(19) United States
(12) Patent Application Publication
(10) Pub. No.: US 2017/0075387 A1
(43) Pub. Date: Mar. 16, 2017

(54) Optical Projection Computer

(71) Applicant: Beijing Jiatuosi Technology Co., Ltd., Beijing (CN)

(72) Inventors: Mingxin Hou, Haerbin (CN); Yunpeng Gao, Haerbin (CN)

(21) Appl. No.: 15/190,453

(22) Filed: Jun. 23, 2016

(30) Foreign Application Priority Data
Sep. 12, 2015 (CN) 201510576926.X

(51) Int. Cl. G06F 1/16; G06F 3/03

(52) U.S. Cl. CPC G06F 1/1639; G06F 1/1686; G06F 3/0304

(57) ABSTRACT

An optical projection computer mainly includes a micro-projection module for displaying the content of the computer; a Mini PC module for integrating the relevant functions of the computer; an optical projection keyboard/mouse module for generating an optical keyboard zone or an optical mouse zone; the optical projection keyboard/mouse module, Mini PC module and micro-projection module are connected successively. With the design scheme set forth, the optical projection computer will have the features of low weight, small size and favorable portability.

### CROSS-REFERENCE TO RELATED APPLICATIONS

The present application claims the benefit of Chinese Patent Application No. 201510576926.X filed on Sep. 12, 2015, the contents of which are hereby incorporated by reference.

### FIELD OF THE INVENTION

The invention relates to an optical projection computer and particularly to a method for combining the micro-projection, Mini PC and optical projection keyboard and mouse.

### BACKGROUND

The development of desktop has promoted the application and popularization of computers, while the invention of laptop has boosted the portability of computers. From the invention of desktop to the popularization of laptop, it can be seen that the development of computer has a tendency of being smaller and lighter. Although the desktop and laptop make the office affairs more easily handled, the screen for human-computer interaction and the keyboard and mouse for physical inputting are both entities with heavy weight and large size.

### SUMMARY OF THE INVENTION

The invention provides a method for combining the micro-projection, Mini PC and optical projection keyboard and mouse to reduce the size and weight of the computer and increase its portability through the integration of the three modules.

The invention provides an optical projection computer, which includes a micro-projection module for displaying the content of the computer; a Mini PC module for integrating the relevant functions of the computer; an optical projection keyboard/mouse module for projecting the keyboard and mouse for inputting by the user. The optical projection keyboard/mouse module, Mini PC module and micro-projection module are connected successively.

The optical projection keyboard/mouse module includes a device zone and a projection zone.

The device zone of the optical projection keyboard/mouse module includes an optical projection processor, a projector, a camera and a laser device.

The Mini PC module is an entity part of the computer.

The Mini PC module includes a CPU, an internal memory, a flash memory, a WiFi module, a Bluetooth module and a USB module.

The micro-projection module includes an optical engine, a DLPA, a memorizer and a DLPC.

The optical projection computer also includes a projection light path and a projection plane; the optical engine projects onto the projection plane through the projection light path and the projection plane displays the content of the computer.

The Mini PC module is suitable for operating Windows system, Android system, Linux system or Mac system.

The projection plane is any of a projection curtain or a projection wall.

The processor of the Mini PC uses any of the CPU of Intel, ARM chip, DSP chip, FPGA chip or SCM chip.

The Mini PC module connects to a Bluetooth keyboard or mouse through an external extension of the Bluetooth module of the Mini PC module or to a USB keyboard, USB mouse or USB 2.4G wireless module through an external extension of the USB module.

A method for using the optical projection computer, wherein, includes the following step of:
generating a keyboard zone or mouse zone through the optical projection keyboard/mouse module;
inputting relevant content in the keyboard zone or mouse zone by the user;
displaying the relevant content input by the user on the projection plane generated by the micro-projection module after being processed by the Mini PC module.

The micro-projection module will conduct manual or automatic focusing to obtain a clear projection correspondingly based on the distance of the projection plane.

The user can input in the projected keyboard zone and operate mouse in the projected mouse zone. The invention reduces the size and weight of the computer and increases its portability through the integration of the three modules.

### BRIEF DESCRIPTION OF THE DRAWINGS

FIG. 1 is a framework schematic diagram of the optical projection computer of the invention.

FIG. 2 is a framework schematic diagram of the optical projection keyboard/mouse module of the invention.

FIG. 3 is a framework schematic diagram of the Mini PC module of the invention.

FIG. 4 is a framework schematic diagram of the micro-projection module of the invention.

### DESCRIPTION OF THE PREFERRED EMBODIMENTS

The invention is further described in combination with Embodiments and Drawings as follows.

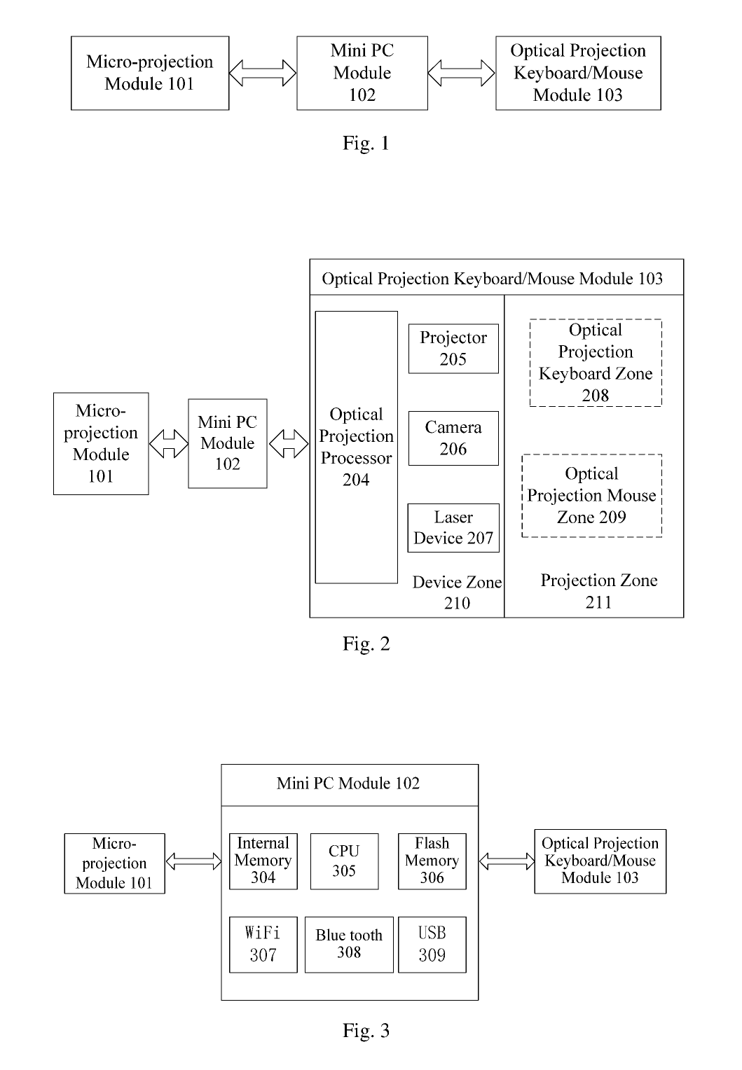

The optical projection computer of the invention as shown in FIG. 1 mainly includes three parts as a micro-projection module 101, a Mini PC module 102 and an optical projection keyboard and mouse module 103.

The micro-projection module 101 is adopted to generate a projection plane viewable for the user on which the relevant content of the computer is displayed.

The Mini PC module 102 is the main body of the computer.

The optical projection keyboard and mouse module 103 generates an optical projection keyboard zone and mouse zone or reserve a keyboard zone only.

FIG. 2 is a schematic diagram of the optical projection keyboard/mouse module 103 of the invention. The optical projection keyboard/mouse module 203 mainly includes two parts as a device zone 210 and a projection zone 211.

The device zone 210 of the optical projection keyboard/mouse module 103 is a physical entity for hardware, including an optical projection processor 204, a projector 205, a camera 206 and a laser device 207.

The optical projection processor 204 is designed based on the ARM, DSP, SCM or FPGA chips or the chips designed by the customer, or other types of processor chips.

The projection zone 211 is the operation zone for the user, including an optical projection keyboard zone 208 and an optical projection mouse zone 209; wherein, the optical projection keyboard zone 208 is adopted to display a laser projection keyboard viewable for the user and the optical projection mouse zone 209 is adopted to control the mouse by sliding fingers of the user. One of the optical projection keyboard zone 208 and the optical projection mouse zone 209 can be reserved and the both zones can be reserved either.

FIG. 3 is a schematic diagram of the Mini PC module 102 of the invention. The Mini PC module 102 mainly includes six parts as a CPU 305, an internal memory 304, a flash memory 306 (also known as EMMC, embedded multimedia card, system memory, embedded memorizer, hard disk, Flash, etc.), a WiFi module 307, a Bluetooth module 308 and a USB module 309.

The Mini PC module 102 is the main body of a microcomputer; and other functional modules as FM, audio speaker, Zigbee communication, etc. can further be added.

The Mini PC module 102 is suitable for operating such systems as Windows, Android, Linux, Mac, etc.

The CPU 305 of the Mini PC uses any of the CPU of Intel, ARM chip, DSP chip, FPGA chip or SCM chip, etc.

The user at the input end of the Mini PC module 102 can input the content in the optical projection keyboard zone 208 and operate in the optical projection mouse zone 209, or input and operate through external extended devices of the Bluetooth module 308 and USB module 309 of the Mini PC module 102, such as Bluetooth keyboard, Bluetooth mouse, USB keyboard, USB mouse, or input and operate through an external USB wireless 2.4G module.

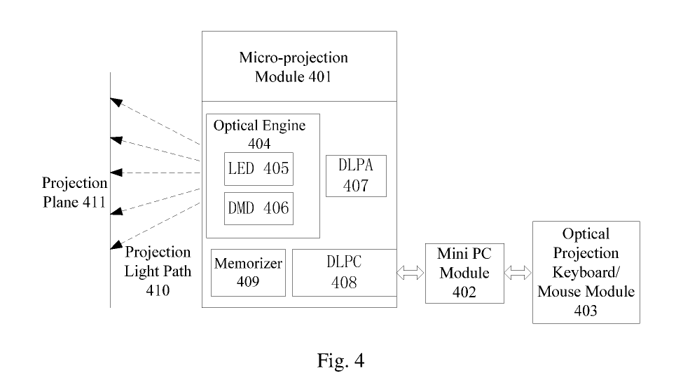

FIG. 4 is a schematic diagram of the micro-projection module 101 of the invention. The micro-projection module 101 mainly includes an optical engine 404, a DLPA (Power Management and LED Driver) (also known as PAD) 407, a DLPC (Display Controller) 408 and a memorizer 409.

The optical engine 404 includes a LED 405 and a DMD 406.

The optical engine 404 is adopted to generate a light ray viewable for the user onto a projection plane 411 through a projection light path 410.

The projection plane 411 is a projection curtain or wall or other objects; wherein, the micro-projection module 101 will conduct manual or automatic focusing to obtain a clear projection correspondingly based on the distance of the projection plane 411.

The above is only a further detailed description for the invention in combination with the specific preferred embodiments and the embodiments of the invention are not limited to it. For a person skilled in the art, the simple deductions or substitutions under the premise of not departing from the concept of the invention can be carried out, which will fall within the protection scope of the invention.

What is claimed is:

1. An optical projection computer, comprising:
a micro-projection module for displaying the content of the computer;
a Mini PC module for integrating the relevant functions of the computer;
an optical projection keyboard/mouse module for generating an optical keyboard zone or an optical mouse zone;
the optical projection keyboard/mouse module, Mini PC module and micro-projection module are connected successively.

2. The optical projection computer according to claim 1, wherein, the optical projection keyboard/mouse module comprises a device zone and a projection zone.

3. The optical projection computer according to claim 2, wherein, the device zone of the optical projection keyboard/mouse module comprises an optical projection processor, a projector, a camera and a laser device.

4. The optical projection computer according to claim 1, wherein, the Mini PC module is an entity part of the computer.

5. The optical projection computer according to claim 4, wherein, the Mini PC module comprises a CPU, an internal memory, a flash memory, a WiFi module, a Bluetooth module and a USB module.

6. The optical projection computer according to claim 1, wherein, the micro-projection module comprises an optical engine, a DLPA, a memorizer and a DLPC.

7. The optical projection computer according to claim 6, further comprising a projection light path and a projection plane; the optical engine projects onto the projection plane through the projection light path and the projection plane displays the content of the computer.

8. The optical projection computer according to claim 4, wherein, the Mini PC module is suitable for operating Windows system, Android system, Linux system or Mac system.

9. The optical projection computer according to claim 7, wherein, the projection plane is any of a projection curtain or a projection wall.

10. The optical projection computer according to claim 4, wherein, the processor of the Mini PC uses any of the CPU of Intel, ARM chip, DSP chip, FPGA chip or SCM chip.

11. The optical projection computer according to claim 5, wherein, the Mini PC module connects to a Bluetooth keyboard or mouse through an external extension of the Bluetooth module of the Mini PC module or to a USB keyboard, USB mouse or USB 2.4G wireless module through an external extension of the USB module.

12. A method for using the optical projection computer, comprising the following steps of:
generating a keyboard zone or mouse zone through the optical projection keyboard/mouse module;
inputting relevant content in the keyboard zone or mouse zone by the user;
displaying the relevant content input by the user on the projection plane generated by the micro-projection module after being processed by the Mini PC module.

13. The method for using the optical projection computer according to claim 12, wherein, the micro-projection module will conduct manual or automatic focusing to obtain a clear projection correspondingly based on the distance of the projection plane.
